(19) United States
(12) Patent Application Publication
(10) Pub. No.: US 2025/0247029 A1
(43) Pub. Date: Jul. 31, 2025

(54) SENSORLESS MOTOR CONTROL SYSTEM FOR A POWER TOOL AND METHOD FOR DETERMINING AN INITIAL ROTOR POSITION OF A SENSORLESS MOTOR

(71) Applicant: BASSO INDUSTRY CORP, Taichung (TW)

(72) Inventors: Cheng-En TSAI, Taichung (TW); Pei-Yuan Hung, Taichung (TW); Chin-Cheng Lee, Taichung (TW); Hung-Wei Chen, Taichung (TW)

(73) Assignee: BASSO INDUSTRY CORP, Taichung (TW)

(21) Appl. No.: 18/983,825

(22) Filed: Dec. 17, 2024

(30) Foreign Application Priority Data
Jan. 25, 2024 (TW) 113200908

(51) Int. Cl. H02P 6/18; H02P 6/182; H02P 6/20; H02P 6/24

(52) U.S. Cl. CPC H02P 6/181; H02P 6/182; H02P 6/20; H02P 6/24

(57) ABSTRACT

A sensorless motor control system includes a drive unit and a control unit. The drive unit includes a motor having three phase windings and a rotor, and an actuation circuit connected to the three phase windings. The actuation circuit includes three switch units each including a high-side switch and a low-side switch.

The control unit is configured to alternately actuate the high-side switches respectively of the three switch units and the low-side switches respectively of the three switch units such that the high-side switch of one of the three switch units and the low-side switch of a different one of the three switch units are actuated during each of a plurality of detection cycle periods, record an actuation duration during each of the detection cycle periods, and determine a position of the rotor based on the actuation durations recorded respectively for the detection cycle periods.

### CROSS-REFERENCE TO RELATED APPLICATION

This application claims priority to Taiwanese Utility Model Patent Application No. 113200908, filed on Jan. 25, 2024, the entire disclosure of which is incorporated by reference herein.

### FIELD

The disclosure relates to a sensorless motor control system for a power tool, and a method for determining an initial rotor position of a sensorless motor.

### BACKGROUND

In the field of power tools, Hall sensors are typically mounted at positions corresponding to magnets of a rotor to detect changes in the magnetic field, allowing for the determination of a rotor position during motor operation for control purposes. However, the use of Hall sensors increases the cost and complexity of motors. Therefore, a conventional sensorless motor detects a back electromotive force (BEMF) of the motor for enhanced operation control.

The principle is that, when the conventional sensorless motor is running, the BEMF of three phase windings of the conventional sensorless motor will change with rotation of the rotor. Therefore, a rotor position can be determined based on changes in the BEMF that are detected while the conventional sensorless motor is running, and motor control of the conventional sensorless motor can be performed accordingly. However, when the conventional sensorless motor is not running or running at a low speed, the BEMF is weak and difficult to measure and determine. Therefore, conventional sensorless motors usually use a high-frequency injection method to determine the rotor position during startup. After the startup, the conventional sensorless motor is then controlled based on the BEMF.

However, the high-frequency injection method requires an additional high-frequency injection voltage and subsequent calculations are required to be performed based on the measured current. This approach not only requires additional circuitry, which increases costs, but the complexity of the calculations also adds to design time and expense.

### SUMMARY

Therefore, an object of the disclosure is to provide a sensorless motor control system for a power tool, and a method for determining an initial rotor position of a sensorless motor that can alleviate at least one of the drawbacks of the prior art.

According to an aspect of the disclosure, the sensorless motor control system includes a power unit, a drive unit, a detection unit, and a control unit. The power unit includes a battery pack for providing power. The drive unit includes a motor that has three phase windings and a rotor, and an actuation circuit that is electrically connected to the three phase windings. The actuation circuit includes three switch units that are electrically connected respectively to the three phase windings. Each of the three switch units includes a high-side switch and a low-side switch that are connected in series and that have a common node. The common node is electrically connected to a respective one of the three phase windings. The detection unit includes a current detection circuit for detecting a current of the motor. The control unit is electrically connected to the power unit, the actuation circuit, and the detection unit.

The control unit is configured to, when the motor is being activated, control the actuation circuit to alternately actuate the high-side switches respectively of the three switch units and alternately actuate the low-side switches respectively of the three switch units during a plurality of detection cycle periods in such a manner that the high-side switch of one of the three switch units and the low-side switch of a different one of the three switch units are actuated during each of the plurality of detection cycle periods. The control unit is further configured to, during each of the plurality of detection cycle periods, when determining that the current of the motor fulfills a predetermined condition, stop actuating the high-side switch of the one of the three switch units and the low-side switch of the different one of the three switch units, and record an actuation duration for which the high-side switch of the one of the three switch units and the low-side switch of the different one of the three switch units are actuated during the detection cycle period. The control unit is further configured to determine a position of the rotor of the motor based on one of the high-side switches of the three switch units and one of the low-side switches of the three switch units that correspond to a shortest one of the actuation durations that were recorded respectively for the plurality of detection cycle periods.

According to another aspect of the disclosure, the method for determining an initial rotor position of a sensorless motor is to be implemented by the above mentioned sensorless motor control system. The method includes: by the control unit, when the motor is being activated, controlling the actuation circuit to alternately actuate the high-side switches respectively of the three switch units and alternately actuate the low-side switches respectively of the three switch units during a plurality of detection cycle periods in such a manner that, the high-side switch of one of the three switch units and the low-side switch of a different one of the three switch units are actuated during each of the plurality of detection cycle periods; by the control unit, during each of the plurality of detection cycle periods, when determining that the current of the motor fulfills a predetermined condition, stop actuating the high-side switch of the one of the three switch units and the low-side switch of the different one of the three switch units, and recording an actuation duration for which the high-side switch of the one of the three switch units and the low-side switch of the different one of the three switch units are actuated during the detection cycle period; and by the control unit, determining a position of the rotor of the motor based on one of the high-side switches of the three switch units and one of the low-side switches of the three switch units that correspond to a shortest one of the actuation durations that were recorded respectively for the plurality of detection cycle periods.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic block diagram illustrating a sensorless motor control system for a power tool according to an embodiment of the present disclosure.

FIG. 2 is a waveform diagram illustrating self-induced voltages measured respectively at U-phase, V-phase and W-phase of a motor, and current of the V-phase during startup of the sensorless motor control system according to an embodiment of the present disclosure.

FIG. 3 is a flow chart illustrating operations of the sensorless motor control system according to an embodiment of the present disclosure.

FIG. 4 is a waveform diagram illustrating back electromotive forces measured respectively at the U-phase, the V-phase, and the W-phase of the motor according to an embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

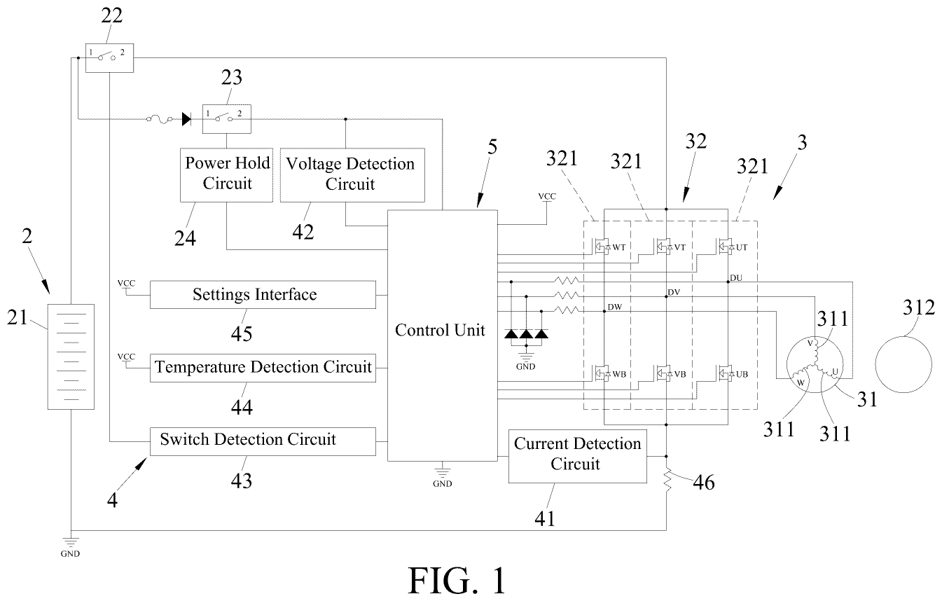

Referring to FIG. 1, a sensorless motor control system for a power tool according to an embodiment of the present disclosure includes a power unit 2, a drive unit 3, a detection unit 4, and a control unit 5. In one embodiment, the power tool is exemplified by, for example, a grinding power tool, such as a grinder, but this disclosure is not limited in this respect.

The power unit 2 includes a battery pack 21, a primary switch 22, a secondary switch 23, and a power hold circuit 24. The battery pack 21 provides power (VCC) relative to ground (GND). The primary switch 22 is electrically connected to and between the battery pack 21 and the drive unit 3, and is operable by a user to switch between a conducting state and a non-conducting state. The secondary switch 23 is electrically connected to and between the battery pack 21 and the control unit 5 for providing a delay-time power, and is switchable between a conducting state and a non-conducting state. The power hold circuit 24 is electrically connected to the secondary switch 23 and the control unit 5. When the user actuates the primary switch 22 (i.e., switching the primary switch 22 into the conducting state), the control unit 5 controls the power hold circuit 24 to cause the secondary switch 23 to switch into the conducting state, and remain in the conducting state. When the user stops actuating the primary switch 22 (i.e., switching the primary switch 22 into the non-conducting state), the control unit 5 controls the power hold circuit 24 to cause the secondary switch 23 to switch into the non-conducting state after delaying for a period of time. Specifically, the secondary switch 23 continues to provide the delay-time power to the control unit 5 during the period of delay in switching to the non-conducting state in order for the control unit 5 to execute a shutting down procedure (e.g., interrupting a running program, saving a program temporary data, etc.). The power hold circuit 24 may be exemplified as an electronic circuit that has a function of switching the secondary switch 23 between the conducting state and the non-conducting state.

The drive unit 3 includes a motor 31 that has three phase windings 311 and a rotor 312, and an actuation circuit 32 that is electrically connected to the three phase windings 311 and the control unit 5. In this embodiment, the motor 31 is exemplified by a sensorless brushless motor. For example, the motor 31 may be realized using a sensorless brushless direct current motor, but this disclosure is not limited in this respect. In this embodiment, the motor 31 is exemplified as a three-phase motor that has three phases (U, V, W), namely the U-phase, the V-phase and the W-phase, respectively, and the three phase windings 311 respectively correspond to the U-phase, the V-phase and the W-phase.

The actuation circuit 32 receives control signals in the form of pulse-width modulation (PWM) signals from the control unit 5, and drives the motor 31 to rotate based on a duty cycle of the PWM signals. The actuation circuit 32 includes three switch units 321 that are electrically connected respectively to the three phase windings 311. Each of the three switch units 321 includes a high-side switch (UT, VT, WT) and a low-side switch (UB, VB, WB) that are connected in series and that have a common node. The common node is electrically connected to a respective one of the three phase windings 311 and to the control unit 5. Specifically, the common node is electrically connected to a respective one of the three phase windings 311. Each of the high-side switches (UT, VT, WT) and the low-side switches (UB, VB, WB) may be exemplified by, for example, a metal-oxide-semiconductor field-effect transistor (MOSFET), a bipolar junction transistor (BJT), an insulated-gate bipolar transistor (IGBT), etc. In this embodiment, each of the high-side switches (UT, VT, WT) and the low-side switches (UB, VB, WB) is exemplified as a MOSFET that has a gate terminal, a source terminal and a drain terminal. The control unit 5 outputs the control signals to the gate terminals of the high-side switches (UT, VT, WT) and the low-side switches (UB, VB, WB), individually controlling each high-side switch (UT, VT, WT) and each low-side switch (UB, VB, WB) to conduct or not to conduct. For each of the three switch units 321, the source terminal of the high-side switch (UT, VT, WT) is electrically connected to the drain terminal of the low-side switch (UB, VB, WB). The control unit 5 continuously detects voltage at the common node of the high-side switch (UT, VT, WT) and the low-side switch (UB, VB, WB) of each of the three switch units 321. When the motor 31 is running, the control unit 5 detects back electromotive forces (BEMFs) (DU, DV, DW) respectively from the three phase windings 311 through the common node of the high-side switch (UT, VT, WT) and the low-side switch (UB, VB, WB) of each of the three switch units 321.

The detection unit 4 is electrically connected to the control unit 5, and includes a current detection circuit 41, a voltage detection circuit 42, a switch detection circuit 43, a temperature detection circuit 44, and a settings interface 45.

In one embodiment, the current detection circuit 41 is exemplified by, for example, an operational amplifier, and is used in cooperation with a shunt resistor 46 for detecting a current of the motor 31. The current detection circuit 41 transmits detected information of the current of the motor 31 to the control unit 5 in order for the control unit 5 to monitor the current of the motor 31.

The voltage detection circuit 42 is electrically connected to and between the battery pack 21 and the control unit 5 through the secondary switch 23. The voltage detection circuit 42 is configured to detect a voltage of the battery pack 21, and to transmit detected information of the voltage of the battery pack 21 to the control unit 5 for the control unit 5 to monitor the voltage of the battery pack 21. In one embodiment, the voltage detection circuit 42 is exemplified by, for example, a voltage divider circuit.

The switch detection circuit 43 is electrically connected to the control unit 5, detects a current state (i.e., the conducting state or the non-conducting state) of the primary switch 22, and outputs the current state of the primary switch 22 detected to the control unit 5. The switch detection circuit 43 detects the current state by way of, for example, when the user actuates the primary switch 22, the primary switch 22 transmits a voltage signal from the battery pack 21 to the actuation circuit 32 and the switch detection circuit 43; when the switch detection circuit 43 receives the voltage signal of the battery pack 21, the switch detection circuit 43 outputs another signal that corresponds to the voltage signal received to the control unit 5; and when the control unit 5 receives the another signal, the control unit 5 determines the current state of the primary switch 22 based on the another signal.

The temperature detection circuit 44 detects a temperature of the motor 31, and transmits the temperature of the motor 31 detected to the control unit 5 for the control unit 5 to perform an overheating protection function. The temperature detection circuit 44 is exemplified by, for example, a thermistor used with a voltage divider circuit.

The settings interface 45 allows the user to adjust settings of the sensorless motor control system, and transmits a settings data set to the control unit 5. For example, the user may set a rotational speed of the motor 31 which allows the control unit 5 to set a duty cycle of the PWM signals that corresponds to the rotational speed of the motor 31 set by the user for output. In one embodiment, the settings interface 45 is exemplified by, for example, a potentiometer, where the control unit 5 calculates the duty cycle of the PWM signals that corresponds to an output of the potentiometer.

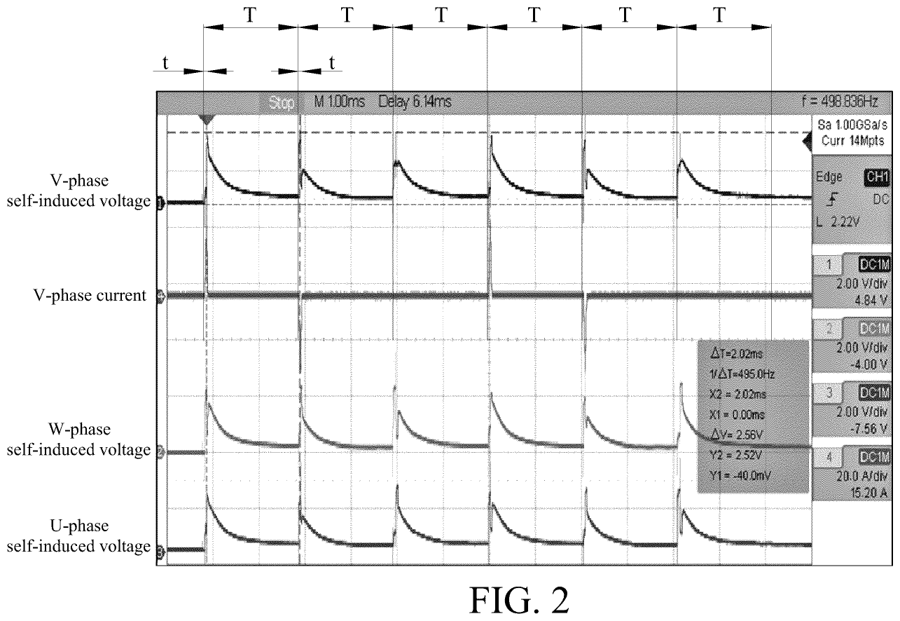

Referring to FIGS. 1 and 2, the control unit 5 may be realized by an integrated circuit that has functions such as analog-to-digital (A/D) conversion, input-output (I/O) detection, PWM output, and rotational speed calculation. For example, the control unit 5 may be exemplified by a microcontroller (MC). When the motor 31 is being activated, the control unit 5 outputs the control signals to the actuation circuit 32, so as to control the actuation circuit 32 to alternately actuate the high-side switches (UT, VT, WT) respectively of the three switch units 321 and alternately actuate the low-side switches (UB, VB, WB) respectively of the three switch units 321 during a plurality of detection cycle periods (T) in such a manner that, the high-side switch (UT, VT, WT) of one of the three switch units 321 and the low-side switch (UB, VB, WB) of a different one of the three switch units 321 (hereinafter referred to as “the actuating switch pair”) are actuated during each of the plurality of detection cycle periods (T). For example, in this embodiment, a number of the detection cycle periods (T) is six, and a number of possible unique combinations of the actuating switch pairs from the three switch units 321 is six. The control unit 5 controls the actuation circuit 32 to actuate the possible unique combinations sequentially, one at a time, during each of the detection cycle periods (T). An example of a sequence by which the actuation circuit 32 actuates the possible unique combinations (hereinafter referred to as “the actuating sequence”) is shown in Table 1 below.

TABLE 1

| Actuating | | | | | | |
|---|---|---|---|---|---|---|
| sequence | 1 | 2 | 3 | 4 | 5 | 6 |
| High-side | VT | WT | UT | VT | UT | WT |
| switch | | | | | | |
| Low-side | UB | VB | WB | WB | VB | UB |
| switch | | | | | | |

During each of the detection cycle periods (T), when the control unit 5 determines that the current of the motor 31 fulfills a predetermined condition, the control unit 5 stops actuating the actuating switch pair, and records an actuation duration (t) for which the actuating switch pair is actuated during the detection cycle period (T). In this embodiment, the predetermined condition is the current of the motor 31 being greater than a predetermined current value. Specifically, the actuation duration (t) is a time duration from the moment the actuating switch pair is actuated, until the moment the current of the motor 31 fulfills the predetermined condition. The control unit 5 determines a position of the rotor 312 of the motor 31 based on one of the high-side switches (UT, VT, WT) of the three switch units 321 and one of the low-side switches (UB, VB, WB) of the three switch units 321 that correspond to a shortest one of the actuation durations (t) that were recorded respectively for the detection cycle periods (T).

Referring to FIG. 2, each of the three phase windings 311 produces a self-induced voltage during the actuation duration (t) in each of the detection cycle periods (T). Each of the detection cycle periods (T) includes the actuation duration (t), a voltage drop duration, and a buffer duration. Since the actuation duration (t) may vary in each of the detection cycle periods (T), a total time duration of each of the detection cycle periods (T) may also vary. The total time duration of each of the detection cycle periods (T) is greater than the voltage drop duration of the respective one of the detection cycle periods (T). The voltage drop duration is taken for the self-induced voltage to drop to a predetermined voltage level (e.g., 0 volts) after the actuating switch pair stops being actuated. By allowing the self-induced voltage to drop to the predetermined voltage level, measurement errors caused by residual self-induced voltage can be avoided. The buffer duration is taken for the control unit 5 to actuate one of the high-side switches (UT, VT, WT) in a next one of the detection cycle periods (T). Specifically, the buffer duration is taken for a voltage at the gate terminal of the corresponding high-side switch (UT, VT, WT) to rise to a level that causes the high-side switch (UT, VT, WT) to be actuated (i.e., to be switched to a conducting state). A time length of the buffer duration can be adjusted based on experimental measured data.

Referring to FIGS. 1 and 2, and using a first one of the detection cycle periods (T) as an example (a left most signal spike waveform in FIG. 2), the control unit 5 starts a timer at the start of the first one of the detection cycle periods (T). According to Table 1, the high-side switch (VT) that corresponds to the V-phase and the low-side switch (UB) that corresponds to the U-phase are the first to be actuated. As the high-side switch (VT) and the low-side switch (UB) are actuated, current flows through two of the three phase windings 311 that correspond to the high-side switch (VT) and the low-side switch (UB), causing the two phase windings 311 to be energized. When the two phase windings 311 are fully charged, a current that is large flows across the two phase windings 311. When the current exceeds the predetermined current value (i.e., the predetermined condition is met), the control unit 5 stops actuating the high-side switch (VT) and the low-side switch (UB), and records the actuation duration (t). In one embodiment, the predetermined current value may be determined through experiments. The first one of the detection cycle periods (T) then enters the voltage drop duration to allow the self-induced voltage to drop to the predetermined voltage level, and then enters the buffer duration, after which the next one of the detection cycle periods (T) starts. After the control unit 5 completes recording the actuation duration (t) for all of the detection cycle periods (T) according to the actuating sequence in Table 1, the control unit 5 determines the position of the rotor 312 of the motor 31. For example, assuming that the actuation duration (t) of the first one of the detection cycle periods (T) is the shortest, the control unit 5 may determine that the rotor 312 is at a position nearest to a phase that corresponds to the high-side switch (VT) and the low-side switch (UB).

The determination of the position of the rotor 312 of the motor 31 mentioned above utilizes a magnetic saturation phenomenon in the inductance of the three phase windings 311 (also known as a stator) of the motor 31. When magnetic flux densities of two of the three phase windings 311 are low, the two of the three phase windings 311 take a longer time to be fully charged, indicating that a permanent magnet (not shown) of the rotor 312 of the motor 31 is out of alignment with the two of the three phase windings 311. On the other hand, when magnetic flux densities of another two of the three phase windings 311 are high, the another two of the three phase windings 311 take a shorter time to be fully charged, indicating that the permanent magnet of the rotor 312 of the motor 31 is in alignment with the another two of the three phase windings 311. Therefore, by alternately energizing two of the three phase windings 311 and calculating the time taken for each pair of the three phase windings 311 to reach the predetermined current value, a current phase of the motor 31 may be determined where a distance or proximity of the permanent magnet of the rotor 312 with respect to each pair of the three phase windings 311 that are energized is estimated. After the current phase of the motor 31 is known and a rotation direction is determined, two of the three phase windings 311 that correspond to a next phase of a rotation phase sequence of the motor 31 from where the rotor 312 is currently located can be energized, thereby driving the rotor 312 to rotate.

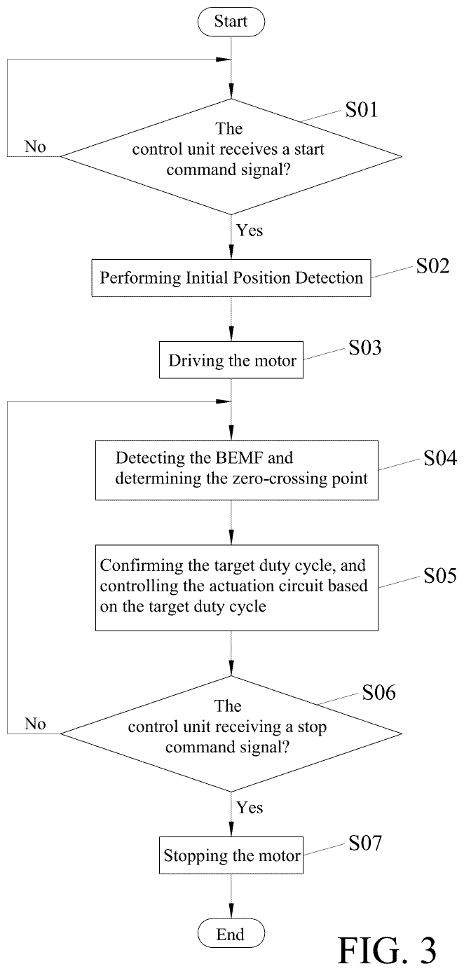

Referring to FIGS. 1, 3 and 4, the control unit 5 is electrically connected to terminal points of the three phases (U, V, W) of the motor 31 (i.e., the common node of the high-side switch (UT, VT, WT) and the low-side switch (UB, VB, WB) of each of the three switch units 321) to detect the BEMFs (DU, DV, DW) of the motor 31. When the motor 31 is driven to rotate, the control unit 5 detects the BEMFs (DU, DV, DW) of the motor 31, and controls the actuation circuit 32 to actuate one of the high-side switches (UT, VT, WT) and one of the low-side switches (UB, VB, WB) that correspond to the next phase of the rotation phase sequence (hereinafter referred to as “the next phase switch pair” for the sake of brevity) of the motor 31 after a delay time (Td) since the control unit 5 detects zero-crossing points (P) of the BEMFs.

A method of controlling the sensorless motor control system according to the present disclosure includes steps S01 to S07.

In step S01, when the control unit 5 receives a start command signal (i.e., when the motor 31 is being activated), the flow goes to step S02. The start command signal is, for example, outputted by the switch detection circuit 43 when the switch detection circuit 43 detects that the primary switch 22 is being actuated (e.g., by a user). At this time, the control unit 5 confirms settings of the user based on the settings data set that is transmitted by the settings interface 45 to set a target rotational speed (i.e., based on the rotational speed of the motor 31 set by the user) or a target duty cycle of the PWM signals (i.e., a duty cycle of the PWM signals that corresponds to the target rotational speed) to be outputted.

In step S02, the control unit 5 performs an initial position detection to determine the position of the rotor 312 (i.e., the current phase) of the motor 31. In this embodiment, the control unit 5 performs the initial position detection by, for example, sequentially actuating the actuating switch pairs from the three switch units 321 according to the actuating sequence in Table 1, recording the actuating duration (t) for each of the detection cycle periods (T), and determining the position of the rotor 312 of the motor 31 according to the shortest one of the actuation durations (t) that were recorded respectively for the detection cycle periods (T). After the position of the rotor 312 of the motor 31 is determined, the flow goes to step S03.

In step S03, based on the position of the rotor 312 obtained in step S02, and the actuating sequence, the control unit 5 controls the actuation circuit 32 to actuate the next phase switch pair of the motor 31 in order to energize two corresponding ones of the three phase windings 311, thereby driving the rotor 312 to rotate. Specifically, the control unit 5 drives the motor 31 by, for example, applying six-step square wave commutation to the three phase windings 311 of the motor 31.

In step S04, when the rotor 312 of the motor 31 starts to rotate, the three phase windings 311 start to produce BEMFs. The control unit 5 detects the BEMFs of the motor 31 and determines the zero-crossing points (P) of the BEMFs in order to determine a timing for the rotor 312 to move to the next phase of the rotation phase sequence based on the changes in the BEMFs detected. The zero-crossing point (P) of each BEMF is determined by the control unit 5 measuring the BEMF of an unenergized one of the three phase windings 311 after the motor 31 starts operating, and comparing the BEMF measured with a neutral point voltage of the motor 31. The control unit 5 determines that the point where the BEMF changes from being lower than the neutral point voltage to higher, or from higher than the neutral point voltage to lower, is considered as the zero-crossing point (P). When the BEMF crosses the zero-crossing point (P), it indicates that the rotor 312 has completed 120 electrical degrees of rotation and has already entered the next 60 electrical degrees.

In step S05, based on the settings done at the settings interface 45, the control unit 5 confirms the target duty cycle, and continues to control the actuation circuit 32 to actuate the next phase switch pair of the motor 31 based on the target duty cycle and the current phase of the motor 31 that corresponds to the position of the rotor 312 of the motor 31, and according to a phase change timing. The phase change timing is the moment when the control unit 5 has waited for an additional 30 degrees of electrical rotation (i.e., the delay time (Td)) after the control unit 5 has detected the zero-crossing point (P) of a corresponding BEMF, and is the moment when the control unit 5 controls the actuation circuit 32 to actuate the next phase switch pair in order for the three phase windings 311 to change to the next phase of the rotation phase sequence of the motor 31, and for the control unit 5 to continue to drive the motor 31 to rotate. That is to say, the delay time (Td) may be determined by, for example, the control unit 5 calculating a time duration for the 30 degrees of electrical rotation to occur after the zero-crossing point (P) of the corresponding BEMF.

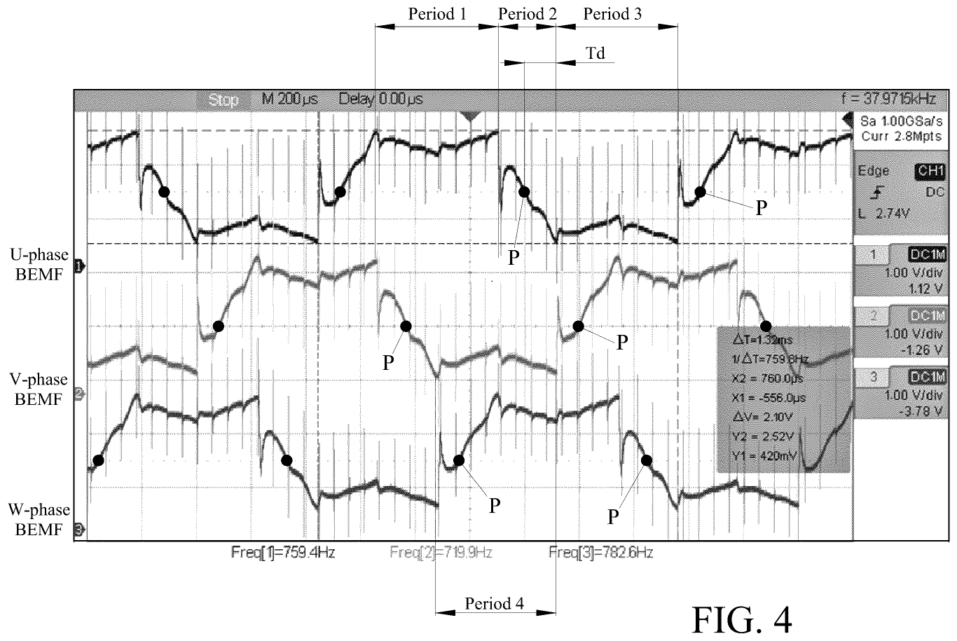

Referring to FIGS. 1 and 4, period 1 is a time period in which the high-side switch UT is actuated, and period 1 corresponds to 120 electrical degrees. At this time, the phase winding 311 that corresponds to the U-phase is energized. Period 2 is a time period between which the high-side switch (UT) stops being actuated and the low-side switch (UB) starts being actuated. Period 2 corresponds to approximately 60 electrical degrees, in which at this time period, the phase winding 311 that corresponds to the U-phase is not energized. Period 1 and period 2 together form half of a rotation cycle of the rotor 312 which corresponds to 180 electrical degrees. During period 2, the control unit 5 determines the zero-crossing point (P) of the BEMF (DU), and controls the actuation circuit 32 to actuate the next phase switch pair of the motor 31 after 30 electrical degrees (i.e., the delay time (Td)), and the U-phase enters period 3. At the same time, a time period of the V-phase depicted by period 4 ends. Period 3 is a time period in which the low-side switch (UB) is actuated, for a total of 120 electrical degrees. Period 4 is the time period in which the low-side switch (VB) is actuated, for a total of 120 electrical degrees. As seen in FIG. 4, the time when period 4 ends and the time when period 3 starts correspond with each other, where the low-side switch (UB) is actuated after the low-side switch (VB) has been actuated for a duration of period 4. With this configuration, during 360 electrical degrees of the rotor 312, the BEMFs of the U-phase, the V-phase and the W-phase produce six zero-crossing points (P). Each time the control unit 5 determines a zero-crossing point (P), the control unit 5 controls the actuation circuit 32 to actuate the next phase switch pair of the motor 31 after the delay time (Td) to continue driving the motor 31 to rotate.

In the method mentioned above, only two of the three phase windings 311 are excited at the same time (i.e., the actuation circuit 32 actuating one of the high-side switches (UT, VT, WT) and one of the low-side switches (UB, VB, WB)). Changes in the BEMF is detected at the remaining one of the three phase windings 311 that is not energized. This configuration enables the control unit 5 to be able to energize the next phase switch pair according to the changes in the BEMF in real time.

Since the actuation circuit 32 needs time to switch the high-side switches (UT, VT, WT) and the low-side switches (UB, VB, WB), and since a process of switching the high-side switches (UT, VT, WT) and the low-side switches (UB, VB, WB) into the conducting state or the non-conducting state directly affects the energization of the three phase windings 311, BEMF waveforms of the actuation circuit 32 during switching of the high-side switches (UT, VT, WT) and the low-side switches (UB, VB, WB) cannot be used to determine whether the BEMF is higher or lower than the neutral point voltage.

In step S06, when the control unit 5 receives a stop command signal, the flow goes to step S07, and the control unit 5 controls the motor 31 to stop rotating. The stop command signal may correspond to the user deactivating the primary switch 22, or the detection unit 4 detecting abnormal readings due to, for example, overvoltage, overcurrent, overheating, etc.

As mentioned above, the sensorless motor control system of the present disclosure includes the drive unit 3, the detection unit 4, and the control unit 5. When the motor 31 is driven to rotate, the control unit 5 controls the actuation circuit 32 to alternately actuate the high-side switches (UT, VT, WT) respectively of the three switch units 321 and alternately actuate the low-side switches (UB, VB, WB) respectively of the three switch units 321 in such a manner that, the high-side switch (UT, VT, WT) of one of the three switch units 321 and the low-side switch (UB, VB, WB) of a different one of the three switch units 321 are actuated during each of the detection cycle periods (T). The control unit 5 then records the actuation duration (t) for each of the detection cycle period (T), and determines the position of the rotor 312 of the motor 31 based on one of the high-side switches (UT, VT, WT) of the three switch units 321 and one of the low-side switches (UB, VB, WB) of the three switch units 321 that correspond to the shortest one of the actuation durations (t) that were recorded respectively for the detection cycle periods (T). The abovementioned way of detecting the position of the rotor 312 at startup does not require additional structures and does not require complex calculations as compared to using the conventional Hall sensor method or high frequency injection method. Therefore, the sensorless motor control system of the present disclosure has the advantages of simple structure and low cost.

In addition, by virtue of the control unit 5 determining the zero-crossing point (P) based on the BEMFs of the motor 31, and controlling the actuation circuit 32 to actuate the next phase switch pair of the motor 31 after the delay time (Td) since the control unit 5 detects the zero-crossing point (P) of the BEMF, the control unit 5 is able to perform commutation of the motor 31 in real time based on the current phase of the motor 31. Therefore, a problem of phase error after long-term operation of the motor 31 can be avoided.

In summary, the sensorless motor control system of the present disclosure is able to alleviate at least one of the drawbacks of conventional sensorless motor control system.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A sensorless motor control system for a power tool, comprising:
a power unit including a battery pack for providing power;
a drive unit including
a motor having three phase windings and a rotor, and
an actuation circuit electrically connected to said three phase windings, and including three switch units that are electrically connected respectively to said three phase windings, each of said three switch units including a high-side switch and a low-side switch that are connected in series and that have a common node, said common node being electrically connected to a respective one of said three phase windings;
a detection unit including a current detection circuit for detecting a current of said motor; and
a control unit electrically connected to said power unit, said actuation circuit, and said detection unit,
wherein said control unit is configured to, when said motor is being activated, control said actuation circuit to alternately actuate said high-side switches respectively of said three switch units and alternately actuate said low-side switches respectively of said three switch units during a plurality of detection cycle periods in such a manner that, said high-side switch of one of said three switch units and said low-side switch of a different one of said three switch units are actuated during each of the plurality of detection cycle periods;
wherein said control unit is further configured to, during each of the plurality of detection cycle periods, when determining that the current of said motor fulfills a predetermined condition, stop actuating said high-side switch of said one of said three switch units and said low-side switch of said different one of said three switch units, and record an actuation duration for which said high-side switch of said one of said three switch units and said low-side switch of said different one of said three switch units are actuated during the detection cycle period; and
wherein said control unit is further configured to determine a position of said rotor of said motor based on one of said high-side switches of said three switch units and one of said low-side switches of said three switch units that correspond to a shortest one of the actuation durations that were recorded respectively for the plurality of detection cycle periods.

2. The sensorless motor control system as claimed in claim 1, wherein the predetermined condition is the current of said motor being greater than a predetermined current value.

3. The sensorless motor control system as claimed in claim 1, wherein each of said three phase windings produces a self-induced voltage during the actuation duration in each of the plurality of detection cycle periods; and
wherein each of the plurality of detection cycle periods includes a voltage drop duration taken for the self-induced voltage to drop to a predetermined voltage level after said high-side switch of said one of said three switch units and said low-side switch of said different one of said three switch units stop being actuated.

4. The sensorless motor control system as claimed in claim 1, wherein each of said three phase windings produces a self-induced voltage during the actuation duration in each of the plurality of detection cycle periods; and
wherein each of the plurality of detection cycle periods includes the actuation duration, a voltage drop duration, and a buffer duration, where the voltage drop duration is taken for the self-induced voltage to drop to a predetermined voltage level after said high-side switch of said one of said three switch units and said low-side switch of said different one of said three switch units stop being actuated, and the buffer duration is taken for said control unit to actuate one of said high-side switches in a next one of the plurality of detection cycle periods.

5. The sensorless motor control system as claimed in claim 1, wherein said motor is a three-phase motor, a number of possible unique combinations of said high-side switch of said one of said three switch units pairing with said low-side switch of said different one of said three switch units is six, and a number of the plurality of detection cycle periods is six; and
wherein said control unit is configured to control said actuation circuit to actuate the possible unique combinations sequentially, one at a time, during each of the plurality of detection cycle periods.

6. The sensorless motor control system as claimed in claim 1, wherein said motor produces a back electromotive force (BEMF) when driven to rotate, and said control unit is further configured to detect the BEMF of said motor, and control said actuation circuit to actuate one of said high-side switches and one of said low-side switches that correspond to a next phase of a rotation phase sequence of said motor after a delay time since said control unit detects a zero-crossing point of the BEMF.

7. A method for determining an initial rotor position of a sensorless motor, the method to be implemented by a sensorless motor control system, the sensorless motor control system including
a power unit having a battery pack for providing power,
a drive unit including
a motor having three phase windings and a rotor, and
an actuation circuit electrically connected to the three phase windings, and including three switch units that are electrically connected respectively to the three phase windings, each of the three switch units including a high-side switch and a low-side switch that are connected in series and that have a common node, the common node being electrically connected to a respective one of the three phase windings,
a detection unit including a current detection circuit for detecting a current of the motor, and
a control unit electrically connected to the power unit, the actuation circuit, and the detection unit,
said method comprising:
by the control unit, when the motor is being activated, controlling the actuation circuit to alternately actuate the high-side switches respectively of the three switch units and alternately actuate the low-side switches respectively of the three switch units during a plurality of detection cycle periods in such a manner that, the high-side switch of one of the three switch units and the low-side switch of a different one of the three switch units are actuated during each of the plurality of detection cycle periods;
by the control unit, during each of the plurality of detection cycle periods, when determining that the current of the motor fulfills a predetermined condition, stop actuating the high-side switch of said one of the three switch units and the low-side switch of said different one of the three switch units, and recording an actuation duration for which the high-side switch of said one of the three switch units and the low-side switch of said different one of the three switch units are actuated during the detection cycle period; and
by the control unit, determining a position of the rotor of the motor based on one of the high-side switches of the three switch units and one of the low-side switches of the three switch units that correspond to a shortest one of the actuation durations that were recorded respectively for the plurality of detection cycle periods.

8. The method as claimed in claim 7, wherein the predetermined condition is the current of the motor being greater than a predetermined current value.

9. The method as claimed in claim 7, wherein each of the three phase windings produces a self-induced voltage during the actuation duration in each of the plurality of detection cycle periods; and
wherein each of the plurality of detection cycle periods includes a voltage drop duration taken for the self-induced voltage to drop to a predetermined voltage level after the high-side switch of said one of the three switch units and the low-side switch of said different one of the three switch units stop being actuated.

10. The method as claimed in claim 7, wherein each of the three phase windings produces a self-induced voltage during the actuation duration in each of the plurality of detection cycle periods; and
wherein each of the plurality of detection cycle periods includes the actuation duration, a voltage drop duration, and a buffer duration, where the voltage drop duration is taken for the self-induced voltage to drop to a predetermined voltage level after the high-side switch of said one of the three switch units and the low-side switch of said different one of the three switch units stop being actuated, and the buffer duration is taken for the control unit to actuate one of the high-side switches in a next one of the plurality of detection cycle periods.

11. The method as claimed in claim 7, the motor being a three-phase motor, wherein a number of possible unique combinations of the high-side switch of said one of the three switch units pairing with the low-side switch of said different one of the three switch units is six, and a number of the plurality of detection cycle periods is six; and
wherein the control unit controlling the actuation circuit to alternately actuate the high-side switches respectively of the three switch units and alternately actuate the low-side switches respectively of the three switch units during the plurality of detection cycle periods includes controlling the actuation circuit to actuate the possible unique combinations sequentially, one at a time, during each of the plurality of detection cycle periods.

12. The method as claimed in claim 7, the motor producing a back electromotive force (BEMF) when driven to rotate, the method further comprising:
by the control unit, detecting the BEMF of the motor, and controlling the actuation circuit to actuate one of the high-side switches and one of the low-side switches that correspond to a next phase of a rotation phase sequence of the motor after a delay time since the control unit detects a zero-crossing point of the BEMF.
